(19) United States
(12) Patent Application Publication
(10) Pub. No.: US 2005/0125122 A1
(43) Pub. Date: Jun. 9, 2005

(54) Coordination of a vehicle stability system with an external vehicle dynamics control system

(76) Inventors: Michael Knoop, Ludwigsburg (DE); Jochen Wagner, Moeglingen (DE); Frank Leibeling, Moeglingen (DE); Oliver Kust, Gerlingen (DE); Peter Zegelaar, Heerlen (NL); Martin Kieren, Schwieberdingen (DE); Gernot Schroeder, Ludwigsburg (DE)

Correspondence Address: KENYON & KENYON, ONE BROADWAY, NEW YORK, NY, 10004, US

(21) Appl. No.: 10/984,306

(22) Filed: Nov. 8, 2004

(30) Foreign Application Priority Data
Nov. 28, 2003 (DE) 103 55 794.6

(51) Int. Cl. G06F 7/00

(52) U.S. Cl. 701/36

(57) ABSTRACT

A method for coordinating a vehicle stability system with an external vehicle dynamics control system, the systems processing various controller variables. The systems may be coordinated particularly well when the vehicle dynamics control system transmits a controller variable to the vehicle stability system and a resulting variable is formed from the supplied controller variable and an own controller variable, the resulting variable being taken into account in a regulation of the vehicle stability system.

### FIELD OF THE INVENTION

The present invention relates to method for coordinating a vehicle stability system with a vehicle dynamics control system, and a vehicle stability system having an interface for external actuating requests.

### BACKGROUND INFORMATION

Vehicle stability systems (VSS), in the following understood to be the ABS (anti-lock brake system), the ASR (anti-spin regulation), or the ESP (electronic stability program) systems, are used to improve the controllability of motor vehicles and to stabilize the vehicle in critical driving situations, such as oversteering when negotiating turns. For this purpose, the vehicle dynamics control system usually uses the vehicle brakes or the engine controller as actuators. The object of the vehicle stability system is to adapt the vehicle behavior to the driver's intent by applying the brakes or via different drive torque distribution under consideration of the driving conditions (road surface condition, speed, etc.).

In addition to vehicle stability systems, modern vehicles oftentimes may also have other vehicle dynamics control systems, such as active spring-damper systems (normal force distribution systems) via which the tire contact force on the individual wheels may be varied. Other examples are active steering systems, such as AFS (active front steering) or EAS (electronic active steering), via which an intended steering angle or active differential systems may be set independently of the steering wheel position.

Vehicle stability systems may generally be designed as closed systems. This means that, apart from the position of momentary-contact switches (on/off), no signals are input externally. Additional vehicle dynamics control systems, such as the aforementioned, are therefore referred to as “external systems.”

Within the scope of vehicle dynamics control, the systems (VSS as well as external systems) determine different state variables, such as a setpoint yaw rate or a setpoint float angle, and, from the system deviation, calculate a necessary stabilizing intervention, a wheel-specific wheel slip, for example. The calculated values are implemented via the appropriate actuators and influence the vehicle behavior.

In order for the systems not to block or interfere with one another, it may be necessary to coordinate the systems and adapt them to one another.

### SUMMARY OF THE INVENTION

Therefore, it is an object of the exemplary embodiment and/or exemplary method of the present invention to provide an exemplary method of the present invention for coordinating a vehicle stability system (VSS) with an external vehicle dynamics control system, and to provide a correspondingly adapted vehicle stability system.

An essential or at least important aspect of the exemplary embodiment and/or exemplary method of the present invention is to make a controller variable (e.g., a setpoint yaw rate) of the external system available, to determine a resulting variable from the external controller variable and the internal VSS controller variable according to a predefined function, and to take this resulting variable into account during a regulation. This has the significant advantage that the VSS and an external system may be coordinated in a simple manner.

The term “controller variable” is understood here to be a variable which is used in a controller algorithm, as well as information from which such a variable may be determined. The controller variable may be, for example, a setpoint variable such as a setpoint yaw rate or a setpoint float angle, a parameter, such as a characteristic speed, or a manipulated variable, such as a braking pressure or a control value for an actuator, or any other variable which is relevant for the vehicle stability system.

The external controller variable may be supplied to the VSS algorithm and calculated in the VSS control unit yielding the resulting variable. To avoid false adjustments, the supplied external controller variable may be subjected to a plausibility check. For this purpose, it may be checked, for example, whether the supplied controller variable lies in a predefined value range, or whether the gradient of the supplied controller variable lies in a predefined range.

According to an exemplary embodiment of the present invention, the VSS is supplied with additional information about the external system's operating state. If, for example, the external system is not in the normal operating state, but in an error mode or a release mode, the external controller variable may not be taken into account.

The external controller variable may also be taken into account in a limited or weighted manner, in particular when it cannot be directly implemented because of capacity reasons of the VSS. If it exceeds predefined limits, the controller variable or its gradient may be reduced for this purpose. Too high a value for the braking pressure, for example, which cannot be implemented by a hydraulic pump of the VSS, may be adapted to the capacity of the predefined system.

According to an exemplary embodiment of the present invention, the external vehicle dynamics control system may also transmit a priority request to the VSS. The priority request is control information via which the control (master/slave) may be transferred from one system to the other system. This allows the vehicle stability system to temporarily consider only the external controller value or variable, thus working only as a “slave,” or working exclusively as a “master,” and not to take the external controller value or variable into account.

According to an exemplary embodiment of the present invention, the external controller variable is monitored with respect to its range. This means that it is checked whether the supplied controller variable (the absolute value or a gradient) lies outside a permissible range. If the variable lies outside the permissible range, it may no longer be taken into account. Processing of external controller variables may be blocked permanently if they lie outside the predefined range too frequently within a predefined time period. Requests which lie outside the predefined range indicate a malfunction of the external vehicle dynamics control system. Such controller variables may therefore not be accepted.

If a controller variable currently processed by the vehicle stability system and the external controller variable differ too greatly from one another, or the currently processed controller variable and a newly calculated resulting variable differ too greatly from one another, a balance control function may be used via which a “sliding” switchover between the previous controller variable and the new controller variable may be carried out. For example, the balance control function uses the interpolation principle to calculate several intermediate values which are taken into account successively, thereby making the regulation considerably smoother.

Instead of transmitting the controller variable as an absolute value, only a selection request may be transmitted. Different parameters, of which one is selected via the selection request, are stored in the VSS in this case. This has the advantage that only sensible values may be selected with which the regulation evidently functions.

The VSS may transmit a feedback to the external vehicle dynamics control system, the feedback including, for example, information about the operating state or the utilization degree of the vehicle stability system. Information about the momentarily processed controller variable, in particular an instantaneous setpoint value or an instantaneous manipulated variable, may also be optionally transmitted to the external system. This has the advantage that the external system is updated, in particular about the instantaneously present manipulated reserve, so that it knows which changes or rates of change of a controller variable, which it transmits to the VSS, may still be implemented.

A vehicle stability system (i.e., ESP, ABS, or ASR) set up to carry out the above-described method includes an interface via which the indicated information or signals are exchanged. The interface is a hardware interface if the VSS and the external vehicle dynamics control system have different control units in which the respective controller algorithm is implemented. If both systems use the same control unit, the interface is situated within the control unit in the form of software.

### BRIEF DESCRIPTION OF THE DRAWINGS

FIG. 1 shows a schematic block diagram of a vehicle stability system VSS and a vehicle dynamics control system.

FIG. 2 shows the steps of a method for coordinating the vehicle stability system with the vehicle dynamics control system during transmission of a setpoint value.

FIG. 3 shows the steps of a method for coordinating the vehicle stability system with the vehicle dynamics control system during transmission of a manipulated variable.

FIG. 4 shows the steps of a method for coordinating the vehicle stability system with the vehicle dynamics control system during transmission of a parameter.

### DETAILED DESCRIPTION

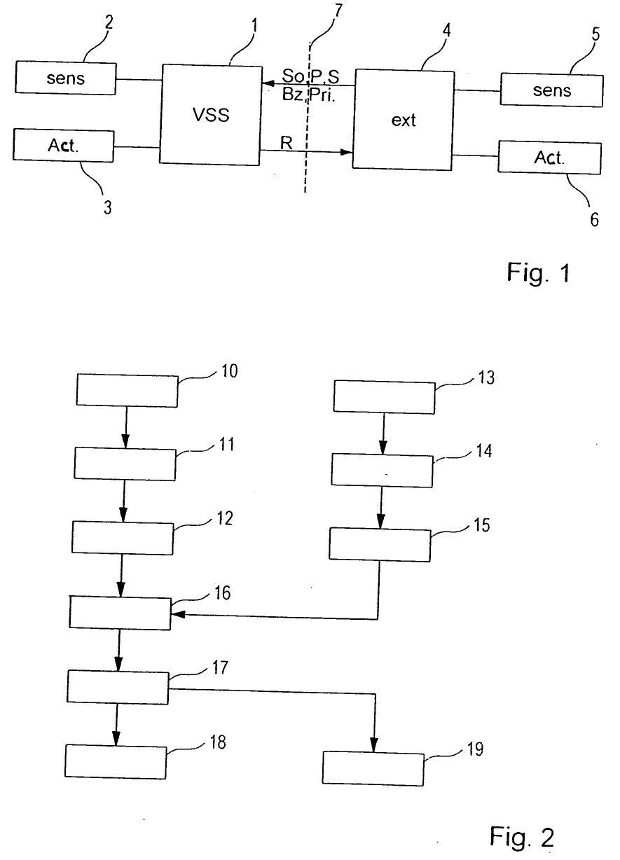

FIG. 1 shows a schematic illustration of a complex controller system including a vehicle stability system VSS having components 1, 2, 3, and an external vehicle dynamics control system having components 4, 5, 6.

The VSS includes the algorithms ESP, ASR, and/or ABS. External vehicle dynamics control system 4, 5, 6 may be, for example, an active spring-damper system (normal force distribution systems), an active steering system, such as EAS, ASS, or another system which is able to intervene in the driving operation.

Vehicle stability system 1, 2, 3 includes a control unit 1, in which a controller algorithm, for example ESP, is stored in the form of software, sensors 2 for determining the controller input variables (actual performance), as well as at least one actuator 3, via which the vehicle behavior may be influenced. Sensors 2 include, for example, a yaw rate sensor, a transverse acceleration sensor, wheel speed sensors, a steering angle sensor, etc., and actuators 3 include, for example, an engine control unit or a hydraulic braking system. All sensors are combined in simplified form in a block 2, and all actuators are combined in simplified form in a block 3.

Vehicle dynamics control system 4, 5, 6 also includes a control unit 4, in which a controller algorithm (for example, EAS) is stored in the form of software, sensors 5 for determining the input variables (actual performance), as well as at least one actuator 6, via which the vehicle behavior may be influenced. The sensors (block 2) of the VSS may at least partially also be used by external vehicle dynamics control system 4, 5, 6. All sensors used by external vehicle dynamics control system 4, 5, 6 are illustrated in simplified form in a block 5, and the actuators are illustrated in simplified form in a block 6. In the case of an active steering system, block 6 includes, for example, a steering actuator via which the steering system may be influenced.

Both systems process and determine their own controller variables, such as setpoint values for the yaw rate, the float angle or a wheel slip, different parameters, such as a characteristic velocity v_{ch}, or manipulated variables, such as a steering angle actuating signal or a braking pressure, the controller variables being implemented by actuators 3, 6. Many controller interventions of external vehicle dynamics control system 4, 5, 6, such as an automatic change in the steering angle, also influence vehicle stability system 1, 2, 3. Both systems 1, 2, 3 and 4, 5, 6 are therefore coordinated as described below.

Vehicle stability system 1, 2, 3 includes an interface 7, via which different information for coordinating the systems is exchanged. (The vehicle stability algorithm and the external vehicle dynamics control algorithm could alternatively also be implemented in a single control unit 1. Interface 7 would then be implemented within control unit 1 in the form of software.) The exchanged information relates to controller variables in particular, and information about the operating state, the capacity, and controlled variables. The coordination of the systems is explained below as an example based on FIGS. 2 through 4.

FIG. 2 shows a flow chart including the essential method steps for coordinating a vehicle stability system 1, 2, 3 with an active vehicle dynamics control system 4, 5, 6, a setpoint value being transmitted to VSS 1, 2, 3.

In step 10, control unit 1 initially reads different sensor signals of sensors 2 in a known manner and performs signal processing in step 11, in which different estimated variables, such as the vehicle longitudinal speed or wheel forces, are determined in addition to the measured variables. The sensor signals may be continuously monitored for plausibility.

In step 12, the determined measured variables and estimated variables are entered into a setpoint formation in which, for example, a setpoint yaw rate and a setpoint float angle are calculated. The setpoint yaw rate is typically calculated according to the Ackermann equation which is also referred to as the “single-track model.” The calculated setpoint yaw rate is dependent on the steering angle and the vehicle's self-steering effect.

The algorithm of external vehicle dynamics control system 4, 5, 6 also calculates a setpoint yaw rate or the setpoint value of a different controller variable. To coordinate the two systems with one another, VSS 1, 2, 3 is supplied with at least one setpoint variable So of external vehicle dynamics control system 4, 5, 6 via interface 7. In step 13, external setpoint value So is read in and is monitored in step 14.

The monitoring of block 14 may include a plausibility check in which it is checked whether the supplied variable has a plausible value or whether the change of the variable lies within predefined limits. In addition, the monitoring of block 14 may include range monitoring or status monitoring. Within the scope of range monitoring it may be provided, for example, that the supplied value is not taken into account when it lies outside the predefined limits too frequently. Status monitoring means that an additional status signal Bz of external vehicle dynamics control system 4 is transmitted and monitored. If an error status is transmitted too frequently within a predefined period of time, consideration of the supplied setpoint value may be suspended, for example.

In step 15, the supplied setpoint value may be limited when it lies outside the predefined limiting values.

In step 16, the (possibly limited) setpoint value is supplied to a coordinator in which the VSS setpoint value and the externally supplied setpoint value are processed and a new resulting setpoint value is calculated. Instead of a concrete setpoint value, a parameter k may also be transmitted, for example, which enters into the calculation of the new resulting setpoint value. The calculation of new resulting setpoint value Gᵣₑₛ may be carried out according to the following function:
Gᵣₑₛ=(1−kₑₓₜ)*G_{VSS}+kₑₓₜ*Gₑₓₜ
where kₑₓₜ is a parameter, G_{VSS} , is a setpoint value determined by VSS 1, 2, 3, and Gₑₓₜ is a setpoint value supplied by external vehicle dynamics control system 4, 5, 6. Setpoint value G_{VSS} originally used by VSS 1, 2, 3 is thus temporarily replaced by new resulting setpoint value Gᵣₑₛ.

If a priority signal Prio is transmitted to control unit 1 in addition to setpoint value Gₑₓₜ, it may be predetermined whether the supplied setpoint value is taken into account by the VSS algorithm, is not taken into account (i.e., only the internal value is taken into account), or whether a resulting setpoint value, forming the basis of the VSS regulation, is calculated from both values.

In step 17, the respective value is taken into account during a regulating phase. In order to avoid sudden setpoint value changes, it is sensible not to abruptly switch the controller algorithm over to the new value, but rather to provide a sliding switchover, by using a balance control function, for example.

Under special conditions, such as high instability of the vehicle or high driving speeds, it may also be sensible to switch back to the VSS setpoint value belonging to the system. A supplied setpoint value So may also not be taken into account when actuators 3 of VSS 1, 2, 3 are being used to full capacity and predefined capacity thresholds are exceeded. This prevents the system from being overloaded.

In step 18, in order to stabilize the vehicle, selected actuators 3 are triggered on the basis of the appropriately considered setpoint value.

In step 19, control unit 1 also outputs a feedback R to external vehicle dynamics control system 4, 5, 6. This feedback may include information about the operating state or a manipulated reserve of VSS 1, 2, 3. External system 4, 5, 6 is thus better able to adapt to the instantaneous state of VSS 1, 2, 3.

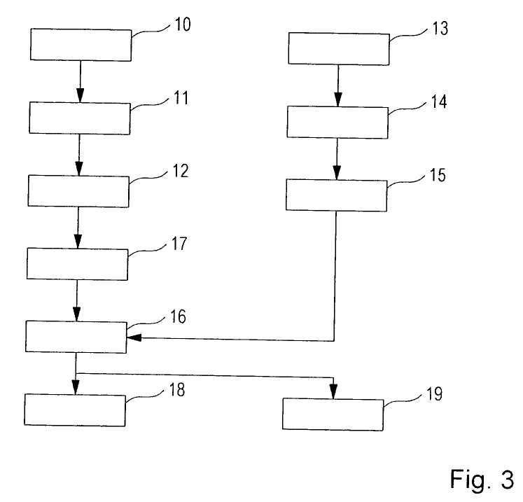

FIG. 3 shows the essential method steps in coordinating a vehicle stability system 1, 2, 3 with an external vehicle dynamics control system 4, 5, 6, a manipulated variable S being transmitted to VSS 1, 2, 3. The same states are labeled here using the same reference numerals as in FIG. 2.

In steps 10, 11, 12, and 17, as described above, different sensor signals are read in, processed, and monitored, a VSS manipulated variable being formed from them in step 17. In this case, an external manipulated variable S, such as a triggering value for a hydraulic pump of the braking system, is transmitted, monitored, and, if needed, limited by control unit 4 (steps 13, 14, 15). Manipulated variable S may also be, for example, a factor k, which is taken into account by the VSS controller algorithm.

In step 17, the controller algorithm outputs a VSS manipulated variable to the coordinator. The coordinator also takes externally supplied manipulated variable S into account and processes both variables into a resulting manipulated variable Gᵣₑₛ in step 16. Resulting manipulated variable Gᵣₑₛ may also be formed using the above-mentioned function.

Actuators 3 are triggered in step 18 on the basis of the newly calculated resulting manipulated variable. If an additional priority signal Prio is transmitted to control unit 1, it may again be predetermined whether the supplied value is taken into account by the VSS algorithm, or whether the resulting manipulated variable is used. In step 19, a feedback R is in turn output to external system 4, 5, 6.

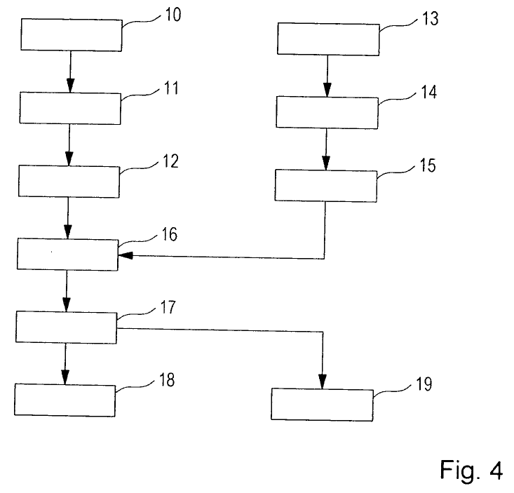

FIG. 4 shows the essential method steps in coordinating a vehicle stability system 1, 2, 3 with an external vehicle dynamics control system 4, 5, 6, a parameter P being supplied to VSS 1, 2, 3. The method essentially corresponds to the method in FIG. 2. The same states are labeled here using the same reference numerals as in FIG. 2.

The essential step is again step 16, in which a resulting parameter Gᵣₑₛ is formed from a parameter belonging to the system and an externally supplied parameter P. Instead of a parameter value, a selection request may optionally be transmitted exclusively via which a value, e.g., for characteristic velocity v_{ch}, which is already stored in control unit 1, is selected. This has the advantage that only sensible values may be taken into account, resulting in transmission errors becoming relatively unproblematic.

The appropriately considered parameter or resulting parameter enters the setpoint value formation of the controller algorithm, for example. The parameter may also be used, for example, to modify different characteristics of the controller algorithm, such as the controller gain.

Both systems may be effectively coordinated with one another using the above-described measures.

The list of reference numerals is as follows:
1 VSS control unit
2 VSS sensors
3 VSS actuators
4 control unit of the vehicle dynamics control system
5 sensors of the vehicle dynamics control system
6 actuators of the vehicle dynamics control system
7 interface
10-18 method steps
So setpoint value
P parameter
S manipulated variable
Bz operating state
Prio priority request
feedback.

1. A method for coordinating a vehicle stability system (VSS) with an external vehicle dynamics control system, the systems processing controller variables, the method comprising:
providing the controller variables by the external vehicle dynamics control system;
determining a resulting variable from the external controller variables and a VSS controller variable according to a predefined function; and
considering the resulting variable during a regulation of the vehicle stability system.

2. The method of claim 1, wherein the controller variables include at least one of a setpoint value, a parameter, and a manipulated variable.

3. The method of claim 1, wherein a provided controller variable is checked for plausibility.

4. The method of claim 1, further comprising:
monitoring a status of the external vehicle dynamics control system is monitored; and
transmitting information about an operating state of the external vehicle dynamics control system to the vehicle stability system;
wherein the vehicle stability system considers or does not consider a provided controller variable as a function of the transmitted information.

5. The method of claim 1, wherein a provided controller variable is limited when it cannot be directly implemented by the vehicle stability system.

6. The method of claim 1, wherein a priority request is transmitted to the vehicle stability system.

7. The method of claim 1, wherein a balance control function is predefined via which the vehicle stability system switches from an instantaneous value of a controller variable to a new value.

8. The method of claim 1, wherein the external vehicle dynamics control system is operable to transmit a selection request for selecting a variable stored in the vehicle stability system.

9. The method of claim 1, wherein the vehicle stability system is operable to transmit feedback information to the external vehicle dynamics control system regarding an operating state or utilization of the vehicle stability system.

10. The method of claim 1, wherein an instantaneously processed setpoint value or an instantaneous manipulated variable is transmitted to the external vehicle dynamics control system.

11. A vehicle stability system for a vehicle having a vehicle dynamics control system in addition to the vehicle stability system, the vehicle dynamics control system including a sensor, an actuator, and a control unit for processing controller variables, the vehicle stability system comprising:
a sensor;
an actuator;
a control unit for processing controller variables;
an interface via which controller variables are suppliable from the vehicle dynamics control system, wherein the vehicle stability system determines a resulting variable, from a controller variable from the vehicle dynamics control system and another controller variable from the vehicle stability system, according to a predefined function, the resulting variable being considered in a regulating function.
